(19) United States
(12) Patent Application Publication
(10) Pub. No.: US 2003/0066993 A1
(43) Pub. Date: Apr. 10, 2003

(54) A FENCING ELEMENT

(76) Inventor: ARNOLD SHIREK CHAMOVE, PALMERSTON NORTH (NZ)

Correspondence Address: BLAKELY SOKOLOFF TAYLOR & ZAFMAN, 12400 WILSHIRE BOULEVARD, SEVENTH FLOOR, LOS ANGELES, CA, 900251026

(21) Appl. No.: 09/117,653

(22) PCT Filed: Jan. 31, 1997
(86) PCT No.: PCT/NZ97/00011

(30) Foreign Application Priority Data
Feb. 2, 1996 (NZ) 280936

(51) Int. Cl. A01K 3/00

(52) U.S. Cl. 256/10

(57) ABSTRACT

It is therefore an object of the present invention to go some way towards overcoming the above-mentioned shortcoming of known fencing systems by providing a visual deterrent to animals.

### BACKGROUND OF THE INVENTION This invention relates to improvements in fencing, in particular electric fencing.

Electric fencing is a primary method used by farmers to manage animal movement. It is used to keep desirable animals in or undesirable animals out through the deterrent of a safe but aversive electric shock. However, in order for known electric fencing systems to be effective, animals usually need to challenge the boundary and experience the electric shock at least once. There is no visual form of deterrent in the fencing which deters animals from making contact with the fence.

In known electric fencing, current from the energiser is carried along the fence through wire or tape. The tape usually consists of a non-conducting polymer matrix plaited, woven, knitted or the like from polymer fibres and conjoined with strands of conducting material such as stainless steel. When in tape form the tape is available in different widths and colours. Generally the wider the width and the lighter the colour, the more visible the tape is to animals since most species are colour blind. However, the appearance alone of known electrified wire and tape does not in itself deter animals from making contact with the fence. The animals therefore have to go through the experience of one or more electric shocks before the appearance of the wire or tape becomes a visual deterrent through learned association. Furthermore, the use of electrified wire, especially under low visibility conditions means that the electric fence may not offer any visual deterrence, acquired or otherwise.

### SUMMARY OF THE INVENTION

It is therefore an object of the present invention to go some way towards overcoming the above-mentioned shortcoming of known fencing systems by providing a visual deterrent to animals.

I have found that certain repetitive markings such as alternating sections of black and white or of other dark and light colours in linear array or spot form tend to ward off animals including domestic farm animals. A possible explanation for this phenomenon is that such animals have a built-in instinct which warns them that other creatures bearing dark and light colouring in an alternating linear pattern or bold spots are harmful and therefore to be avoided. Various poisonous snakes such as the Florida coral snake bear such markings. Honey bees and lady bugs/lady bird beetles are other examples. Furthermore, there are many examples in nature of the mimicry of dangerous animals by harmless animals including a harmless species of snake which has “mimicked” the coral snake's markings in order to ward off predators.

Therefore, according to a broad aspect of the present invention there is provided an elongate fencing element characterised in having clearly visible contrasting markings along the surface of said fencing element, said contrasting markings being such as to resemble the warning patterning of an animal.

According to a second broad aspect of the invention there is provided an elongate fencing element characterised in having alternating sections of dark and light markings in a repetitive linear array so as to resemble the warning patterning present in a particular animal or animals.

In a preferred form of the invention the fencing element comprises electric fencing tape.

In another preferred form of the invention the alternating dark and light markings are in the colours black and white since these colours have been found to be the most effective in deterring animals from making contact with the fence. Nevertheless, it is envisaged that other dark and light or contrasting combinations such as black and yellow (like wasps and hornets) or red, black and white (like the coral snake).

In other forms of the invention the contrasting markings may be in the form of dark spots on a light background or vis-versa or other shapes contrasting with their background. For example the background can be white and the spots black.

### BRIEF DESCRIPTION OF THE DRAWINGS

Specific embodiments of the invention will now be described with reference to the following drawings in which:

FIG. 1 is a side elevation of a known electric fencing tape produced by Gallagher Group Limited,

FIG. 2 is a side elevation of a length of electric fencing tape incorporating alternating light and dark sections according to the present invention and,

FIG. 3 is a side elevation of a length of electric fencing tape incorporating dark spots on a light background according to the present invention.

### DESCRIPTION OF THE PREFERRED EMBODIMENTS

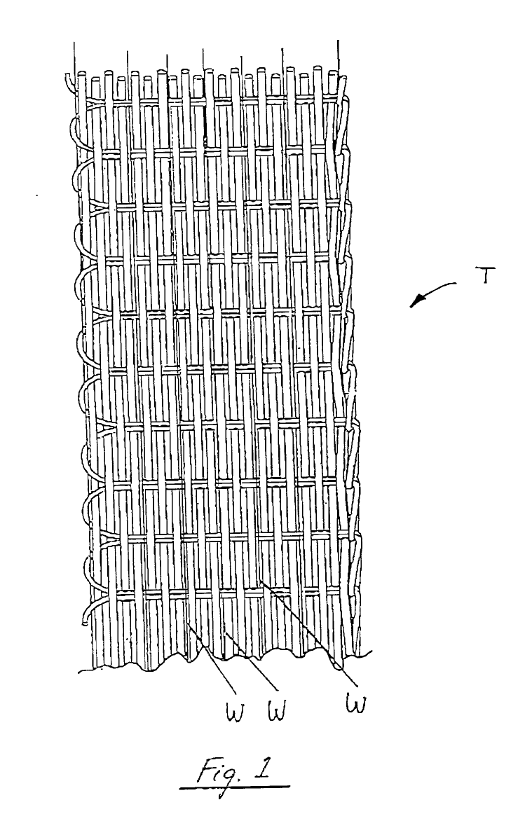

Known electric fencing tape T consists of polymer fibres woven or knitted together with strands of conducting wire W incorporated in the weave as shown in FIG. 1.

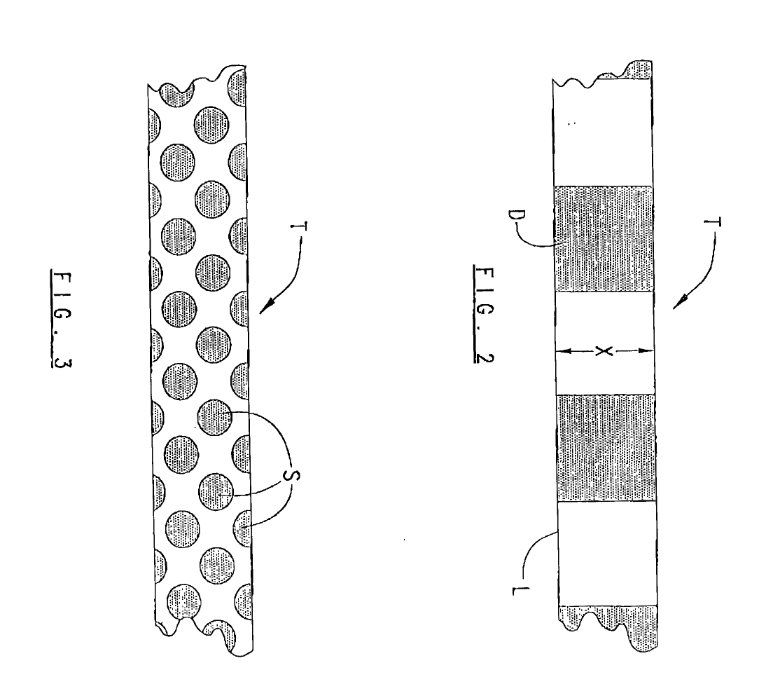

In a preferred embodiment of the present invention as shown in FIG. 2 the width x of the electric fence tape T and longitudinal dimensions of the transverse dark and light markings D and L respectively, are such that the longitudinal dimensions of both D and L are substantially equivalent to the width x of tape T. I have found these dimensions for the dark and light markings to be the most effective in deterring animals from making contact with the fence. However, it will be appreciated that other proportions between the dimensions of the width x of tape T and the length of markings D and L can be found quite satisfactory in performing a deterrent function.

Transverse stripes as shown in FIG. 2 have been found more effective than longitudinal stripes. However, if longitudinal stripes are used then about six even-width stripes on the tape are most effective. The markings can also be in a linear array and diagonally disposed along the fencing element.

In a further embodiment of the invention spots are provided to contrast against the tape background colour (demonstrated in nature by animals such as ladybirds). FIG. 3 illustrates this embodiment with uniformly sized and spaced spots S positioned on the fencing tape T. Further embodiments (not illustrated) may provide spots or other irregular contrasting shapes of differing sizes and patterns to provide the animal deterrent as may be found effective by further study and testing. At present, spots of a diameter about one-sixth the tape width have been found to be most effective.

It will also be appreciated that the fencing means of the present invention may be a non-electrified tape which runs the length of the fence possibly in addition to electrified tape. However, there is economy to be gained in combining the markings of the present invention with the electric fencing tape in one.

Furthermore it will be appreciated that since the fencing means of the present invention presents a visual deterrent to the animal that precludes the animal having to make contact with the fence before being deterred, it is envisaged that non-electrified tape bearing the markings of the present invention may be used without the need for electrification of the fence, especially with horses which are very reactive to tape and to electricity.

It is envisaged that the markings on the present invention may be applied to the fencing means by a painting or printing process either before, or preferably after the polymer fibres are plaited, woven or knitted together. The painting or printing process can apply the markings to either one or both sides of the fencing means.

The markings may also be applied to a gate or other structures to keep animals from contacting it.

The patterned tape may also be used to deter pest animals from contacting crops such as grapes or strawberries simply by the tape's proximity to the vulnerable food crop.

Thus it can be seen that the present invention provides an improvement to fencing, in particular electric fencing by providing a visual deterrent to animals so that they will more likely avoid making contact with the fence. According to the present invention fencing can now have two deterrents to animals—electrification and instinctual warning markings.

1. An elongate fencing element characterized in having clearly visible contrasting markings along the surface of said fencing element, said contrasting markings being such as to resemble the warning patterning of an animal.

2. An elongate fencing element characterised in having alternating sections of dark and light markings in repetitive linear array so as to resemble the warning patterning present in a particular animal or animals.

3. The fencing element of claim 1 or 2 where said fencing element is in the form of electric fencing tape.

4. The fencing element of claim 1 where the contrasting markings are in the form of a repetitive linear array.

5. The fencing element of any one of claims 1 to 3 where the markings are in the form of spots or other regular or irregular shapes on a contrasting background.

6. The fencing element of any of claims 2 to 4 wherein the markings in linear array are transversely disposed along said fencing element.

7. The fencing element of any of claims 2 to 4 wherein the markings in linear array are diagonally disposed along said fencing element.

8. The fencing element of claim 6 wherein the transverse markings are of a width substantially equal to that of said fencing element.

9. The fencing element of any one of the preceding claims where the markings include the colours black and white.

10. The fencing element of any one of claims 1 to 5 wherein the markings utilise any colours or combination of colours which provide a deterrent to a target pest or animal.

11. The fencing element of claim 6 or 7 wherein the colours are limited to three colours.

12. The fencing element of claim 8 wherein the colours are red, black and white.

13. The fencing element of any of the preceding claims wherein the markings are applied using a printing or painting process either before or after the manufacture of said fencing element.

14. An animal or pest barrier comprising a fencing element as claimed in any one of its preceding claims.

15. A fence construction including a fencing element as claimed in any one of the preceding claims.
